(19) United States
(12) Patent Application Publication
(10) Pub. No.: US 2018/0261362 A1
(43) Pub. Date: Sep. 13, 2018

(54) REFLOW SOLDERABLE POSITIVE TEMPERATURE COEFFICIENT CIRCUIT PROTECTION DEVICE

(71) Applicants: LITTELFUSE ELECTRONICS (SHANGHAI) CO., LTD., Shanghai (CN); LITTELFUSE, INC., Chicago, IL (US)

(72) Inventors: Cheng Hu, Shanghai (CN); Chuanrong Miao, Shanghai (CN); Jianhua Chen, Shanghai (CN); Yingsong Fu, Shanghai (CN); Jianming Bu, Shanghai (CN)

(21) Appl. No.: 15/739,923

(22) PCT Filed: Jun. 30, 2016
(86) PCT No.: PCT/CN2016/087863

§ 371 Date: May 24, 2018

(30) Foreign Application Priority Data
Jun. 30, 2015 (CN) 201510372300.7

(51) Int. Cl. H01C 1/144; H01C 7/02; H01C 1/14

(52) U.S. Cl. CPC H01C 1/144; H01C 1/1406; H01C 7/021

(57) ABSTRACT

A reflow solderable positive temperature coefficient circuit protection device is provided, the device comprising: an electrically conductive sheet-like upper terminal composed of a first chip junction portion, a first circuit junction portion, and a connection portion therebetween, wherein the first chip junction portion having a first planar profile; an electrically conductive sheet-like lower terminal comprising a second chip junction portion having a second planar profile; and a positive temperature coefficient chip which is sandwiched between the sheet-like upper terminal and the sheet-like lower terminal, and respectively combined with the lower surface of the first chip junction portion and the upper surface of the second chip junction portion by soldering, and the positive temperature coefficient chip having a third planar profile. The first planar profile and the second planar profile are within the third planar profile, and the third planar profile has a portion that is not covered by the first profile and/or the second profile to allow the positive temperature coefficient chip to have a free thermal expansion space. The device can reduce the stress that causes the device failure and is caused by high-temperature thermal expansion in the device in the protected state.

### TECHNICAL FIELD

The present invention relates to electrical devices, and in particular, to a reflow solderable positive temperature coefficient (PTC) protection device.

### BACKGROUND TECHNOLOGY

PTC chips are widely applied to circuit protection. The PTC chip has low resistance in a normal working state. Once a current in a circuit is too high, the PTC chip generates heat and the temperature of the PTC chip rises. After the temperature of the PTC chip exceeds a particular one, the resistance of the PTC chip increases rapidly and the PTC chip reaches the state of an insulator, and as a result, the circuit is cut off. The PTC chip plays a circuit protection role in this way.

Generally, a PTC chip device is built into a simple layered structure: Sheet-like conductive terminals completely cover a PTC chip that is soldered on two sides. During use, the PTC chip device is mounted on a circuit by soldering two sheet-like conductive terminals to the circuit (for example, on a circuit board).

FIG. 1 is a schematic diagram of a PTC circuit protection device of the existing technology. As shown in FIG. 1, a PTC chip 3 is sandwiched between a conductive upper terminal 1 and a conductive lower terminal 2, and is combined with the upper terminal 1 and the lower terminal 2 by using solder (not shown), to implement a serial connection. The upper terminal 1 has an extending curved junction portion 103 and a circuit junction portion 105. During mounting, the lower terminal 2 and the circuit junction portion 105 of the upper terminal 1 are reflow soldered to a circuit, for example, on a circuit board. The upper terminal 1 and the lower terminal 2 completely cover the PTC chip 3.

The PTC circuit protection device of the existing technology shown in FIG. 1 is simple, but has the following problems. First, when being in a protected state (that is, a high-temperature state), the PTC chip is at a high temperature and thermal expansion occurs. However, sheet-like conductive terminals that completely cover the PTC chip are securely soldered on the circuit and can hardly deform. Therefore, the space for thermal expansion of the PTC chip is greatly restricted, and consequently, enormous internal stress is generated in the device. The stress may cause the PTC chip to damage physically and burn out, or may cause solder between the circuit junction portion 105 and the circuit to become loose, resulting in the impact on the reliability of the circuit, that is, an electronic apparatus. This is especially severe when the PTC chip is a polymeric PTC (PPTC) chip. In general, thermal expansion occurs, if the structure of a conventional PTC chip device is used, great stress generated affects the reliability of products. Next, during manufacturing of the PTC chip device, reflow soldering is usually used to solder the sheet-like conductive terminals to the PTC chip, and the reflow soldering technology is usually also used to mount the manufactured chip device to the circuit. Therefore, under a similar reflow soldering condition (for example, hot wind), when the PTC circuit protection device shown in FIG. 1 is soldered on the circuit such as the circuit board by using reflow soldering to complete mounting, solder between the upper and lower terminals and the PTC chip is melted again, and consequently solder balls overflow. The sheet-like conductive terminals completely cover the PTC chip, and therefore, the overflowing solder balls flow to sides of a resistor device, which may cause a “solder bridge” to form between two conductive terminals and consequently cause a short circuit between the terminals after solidification. As a result, the performance of the circuit is affected, or even the PTC chip device fails. In addition, a junction force between a sheet-like upper terminal covering the PTC chip and the PTC chip is sometimes insufficient, and peeling occurs easily.

Therefore, an improved PTC circuit protection device structure is needed, which can reduce the adverse impact on the reliability of a device by thermal expansion of a PTC chip, and at the same time, a “solder bridge” may further be prevented from appearing during reflow soldering for mounting the device.

### SUMMARY OF THE INVENTION

To resolve the foregoing problems, the present invention provides the following technical solutions.

[1] A PTC circuit protection device is provided. The PTC circuit protection device includes: a conductive sheet-like upper terminal, the stated sheet-like upper terminal consisting of a first chip junction portion, a first circuit junction portion, and a connecting portion between them, wherein the first chip junction portion has a first planar profile;

a conductive sheet-like lower terminal, the stated sheet-like lower terminal includes a second chip junction portion, wherein the second chip junction portion has a second planar profile;

a PTC chip that is sandwiched between the sheet-like upper terminal and the sheet-like lower terminal and is separately bonded to a lower surface of the first chip junction portion and an upper surface of the second chip junction portion by using solder, the PTC chip having a third planar profile,

wherein:

the stated first planar profile and the second planar profile are inside the third planar profile, and the stated third planar profile has a portion that is not covered by the first profile and/or second profile, to allow the PTC chip to have a room for free thermal expansion.

[2] The PTC circuit protection device according to [1], wherein

the area of the portion of the third planar profile that is not covered by the first profile is at least 20% of the area of the third planar profile,

and/or

the area of the uncovered portion of the stated third planar profile by the second profile is at least 20% of the area of the third planar profile.

[3] The PTC circuit protection device according to [1], wherein the portion of the stated third planar profile uncovered by the first profile and the portion of the third planar profile uncovered by the second profile are staggered.

[4] The PTC circuit protection device according to [1], wherein

an anti-overflow gap is provided between edges of the first planar profile and the third planar profile, and/or, an anti-overflow gap is provided between edges of the second planar profile and the third planar profile.

[5] The PTC circuit protection device according to [1], wherein

there is a through hole between the first chip junction portion and/or the second chip junction portion.

[6] The PTC circuit protection device according to [5], wherein

the first chip junction portion has a multiple of through holes, and preferably select more than three through holes.

[7] The PTC circuit protection device according to [1], wherein notches are at edges of two sides of the connecting portion.

[8] The PTC circuit protection device according to [1], wherein the connecting portion is curved, so that a lower surface of the first circuit junction portion and a lower surface of the second chip junction portion are basically on the same plane.

[9] The PTC circuit protection device according to [1], wherein the sheet-like lower terminal further includes a circuit junction portion extending from the second chip junction portion.

[10] The PTC circuit protection device according to any one of [1] to [9], wherein the PTC chip is a PPTC chip, the stated PPTC chip includes a PPTC sheet material, the PPTC sheet material contains a conductive powder dispersed in a polymer, the volume ratio of the polymer to the conductive powder is 35:65 to 65:35, the polymer includes at least one selected from polyolefin, a copolymer of at least one olefin and at least one non-olefinic monomer copolymerizable therewith, and a semicrystalline polymer of a thermoformable fluorine-containing polymer, the stated conductive powder includes at least one powder of transition metal carbides, a transitionmetal carbon silicides, transition metal carbon aluminides, and transitionmetal carbon stannides, and a size distribution of the conductive powder satisfies: 20>D₁₀₀/D₅₀>6, wherein D₅₀ denotes a corresponding particle size when a cumulative particle-size distribution percent in the conductive powder reaches 50%, and D₁₀₀ denotes a maximum particle size.

[11] The PTC circuit protection device according to [10], wherein the conductive powder includes titanium carbide, tungsten carbide, titanium silicon carbide, titanium aluminum carbide or titanium tin carbide.

[12] The PTC circuit protection device according to [10], wherein the conductive powder is quasi-spherical.

[13] The PTC circuit protection device according to [10], wherein the size distribution of the conductive powder satisfies:

10>D₁₀₀/D₅₀>6.

[14] The PTC circuit protection device according to [10], wherein the carbon content in the transition metal carbide is less than the theoretical total carbon content in a transition metal carbide MC of a stoichiometric ratio by 2% to 5%, wherein M denotes a transition metal element.

[15] The PTC circuit protection device according to [14], wherein the conductive powder is tungsten carbide WC, and the carbon content T.C. in WC is 5.90% to 6.00%, wherein T.C. is 100%×C/WC by mass; or the conductive powder is titanium carbide TiC, and the carbon content T.C. in TiC is 19.0% to 19.5%, wherein T.C. is 100%×C/TiC by mass.

[16] A method for manufacturing an electronic device including PTC circuit protection one is provided. The PTC circuit protection device according to any one of [1] to [15] is bonded on a circuit by using reflow soldering.

[17] An electronic device is provided. It includes the PTC circuit protection one according to any of [1] to [15] bonded on a circuit by using reflow soldering.

### DESCRIPTION OF THE DRAWINGS

FIG. 1 is a schematic diagram of a PTC circuit protection device in the existing technology.

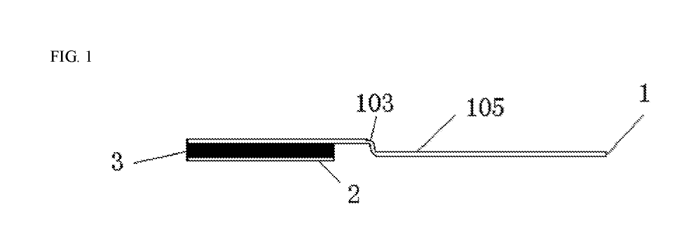

FIG. 2A to FIG. 2C show an appearance diagram of a PTC circuit protection device according to an implementation solution of the present invention.

FIG. 3 is a diagram showing relationships among a junction force between an upper terminal and a PTC chip and through holes in a sheet-like upper terminal.

### DETAILED DESCRIPTION OF THE INVENTION

Detailed implementations are described below according to the present invention in combination with the accompanying drawings.

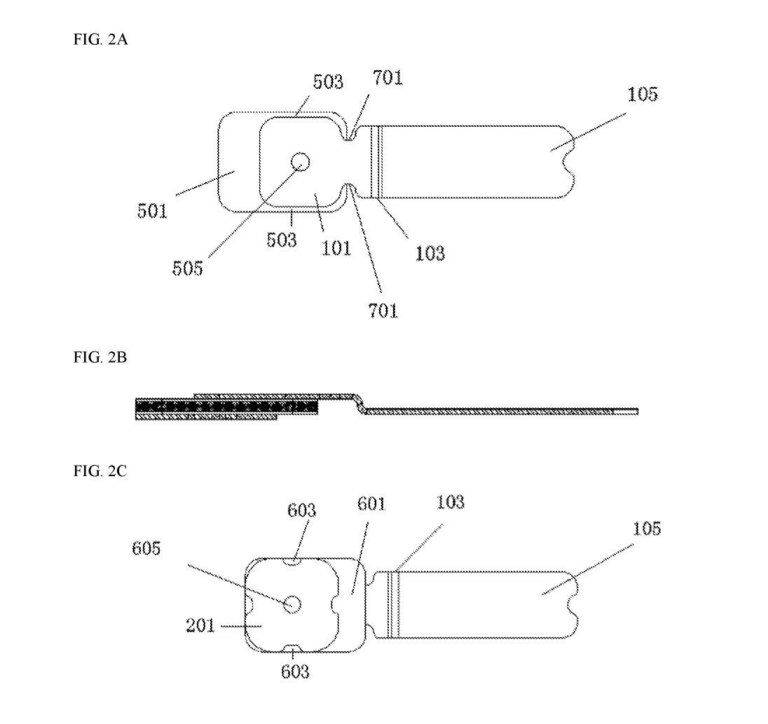

FIG. 2A to FIG. 2C show an appearance diagram of a PTC circuit protection device according to the implementation solution of the present invention. FIG. 2A is a top view seen from above. FIG. 2B is a side view. FIG. 2C is a bottom view seen from below. The upper and lower terminals are made of conductive materials such as a metal, for example, nickel, copper, tin-plated copper, stainless steel, or copper-plated stainless steel. The thickness of a sheet-like terminal is usually between 0.05 mm and 0.5 mm A PTC chip may be a PPTC chip. Although the shown appearance is basically rectangular, terminals and chip materials having any shapes may be optionally used without affecting the effects of the present invention.

FIG. 2A shows that an upper terminal 1 has a circuit junction portion 105, and a portion bonded to the PTC chip (referred to as a first chip junction portion 101), a through hole 505 being seen on the first chip junction portion 101, and a connecting portion 103 between the circuit junction portion 105 and the first chip junction portion 101.

The planar profile (referred to as a first planar profile) of the first chip junction portion 101 is inside a profile (referred to as a third planar profile) of the PTC chip. In other words, the first planar profile is smaller than the third planar profile, and a gap exists between edges of the first planar profile and the third planar one. For example, a relatively large area 501 at an end of the third planar profile is not covered by the first planar one. The area 501 is not restricted spatially by the first chip junction portion 101 of the upper terminal 1, and therefore may expand freely at high temperatures, so that an excessively high internal stress is prevented. To achieve a desired effect of reducing stress, the area 501 preferably accounts for a proportion>20% of the area of the third planar profile, more preferably >25%, and most preferably <50%. The shape of the area 501 is not particularly specified.

A gap 503 exists between the two sides of the first planar profile and an edge of the third planar profile. Because of the presence of the gap 503, when a device is reflow soldered to a circuit, even if solder that is melted again in the device overflows, the solder is kept on the PTC chip around the first planar profile, instead of overflowing to one side to flow downward to form a solder bridge. A gap that can exert the foregoing effect is referred to as “an anti-overflow gap” herein

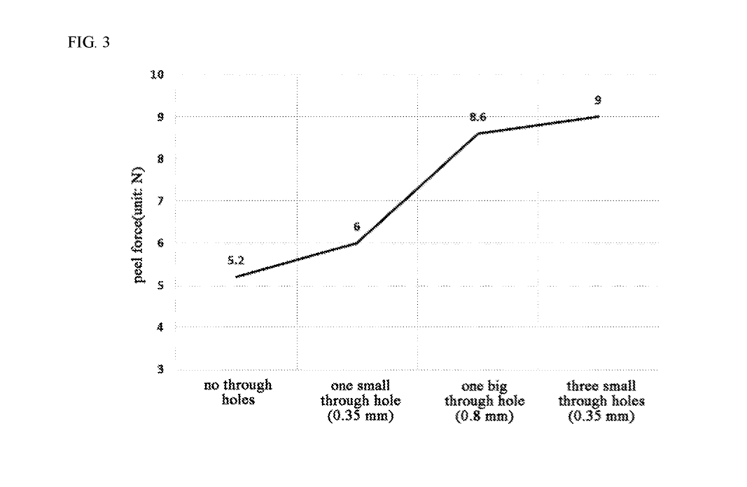

Optionally, the first chip junction portion 101 of the upper terminal 1 may further have any quantity and any shape of through holes 505 to accommodate overflowing solder. When a PTC circuit protection device is soldered to the circuit by means of reflow soldering, if a through hole exists in a sheet-like upper terminal, a particularly beneficial effect will be achieved: a junction force between the upper terminal and the PTC chip is obviously improved. Without being limited to any theory, the reason may be that solder between the upper terminal and the PTC chip is melted again under a reflow soldering condition and enters the through hole, and solder columns form in the through hole after reflow soldering ends and the solder is solidified. On one hand, these solder columns increase a junction area between the solder and the upper terminal. On the other hand, they have an effect of restricting the movement of the upper terminal in the surrounding through holes, thereby generally improving the junction force between the upper terminal and the PTC chip. FIG. 3 shows a relationship between the through holes in the upper terminal and the junction force (a 90-degree peel force vs a hole size and quantity). In the figure, a control example without any through holes is shown, and three embodiments separately have one through hole diameter 0.35 mm, one through hole whose diameter 0.80 mm, and three through holes' diameter are 0.35 mm. As can be seen from the figure, when a hole diameter increases and the hole quantity increases, the junction force is obviously increased. Therefore, the through hole in the sheet-like upper terminal of a reflow solderable PTC circuit protection device, is particularly preferred.

In addition, notch 701 is set up at the connecting portion 103. Preferably, the notches 701 are symmetrically set up on two sides of the connecting portion. The presence of notches makes this portion of the sheet-like upper terminal narrower, so that this portion has better flexibility than other portions. Stress generated inside the upper terminal because of thermal expansion causes the connecting portion to have relatively large elastic deformation at the notches, thereby reducing forces caused by thermal expansion on the other portions of the sheet-like upper terminal, and also reducing a reaction applied on the PTC chip from a circuit board via the upper terminal, so that the PTC chip, the upper terminal, and the circuit board are protected. When there is no curved connecting portion in the circuit protection device, a notch may also be set up. However, when there is a curved portion, the setup of a notch is particularly preferred.

FIG. 2C shows that a planar profile (referred to as a second planar profile) of a portion (referred to as a second chip junction portion 201) of a lower terminal 2 bonded to the PTC chip is inside a profile of the PTC chip (referred to as the third planar profile). Similar to the upper terminal, a relatively large area 601 at one end of the third planar profile is not covered by the second planar profile. The area 601 is basically not restricted spatially by the second chip junction portion 201 of the lower terminal 2, and therefore may expand freely at high temperatures, so that an excessively high internal stress is prevented. To achieve a desired effect of reducing stress, the area 601 preferably accounts for 20% of the area of the third planar profile, more preferably >25%, and preferably <50%. The shape of the area 601 is not particularly specified.

Preferably, the areas 501 and 601, not restricted by the upper and lower terminals are staggered, so that room for free expansion can be provided more efficiently at different portions.

Similarly, an anti-overflow gap 603 exists on two sides of the second planar profile. When a device is reflow soldered to a circuit, even if the solder re-melted in the device overflows, the solder is also kept below the PTC chip around the second planar profile, instead of overflowing to one side and accumulate to form a solder bridge.

Similar to the upper terminal 1, the second chip junction portion 201 of the lower terminal 2 may have any quantity or any shape of through holes 605, wherein the through holes 605 are used to accommodate overflowed solder.

The foregoing structure is especially effective when the PTC chip is a PPTC chip.

According to an embodiment of the present invention, the PPTC chip includes a PPTC sheet material. The stated PPTC sheet material contains a conductive powder dispersed in a polymer. A volume ratio of the polymer to the conductive powder is 35:65 to 65:35. The stated polymer includes at least one selected from polyolefin, a copolymer of at least one olefin and at least one non-olefinic monomer copolymerizable therewith, and a semicrystalline polymer of a thermoformable fluorine-containing polymer. The conductive powder includes at least one powder of a transition metal carbide, a transition metal carbon silicide, a transition metal carbon aluminide, and a transition metal carbon stannide. A size distribution of the conductive powder satisfies: 20>D₁₀₀/D₅₀>6, wherein D₅₀ denotes a corresponding particle size when a cumulative particle-size distribution percent in the conductive powder reaches 50%, and D₁₀₀ denotes a maximum particle size.

Among semicrystalline polymers, polyolefin includes polypropylene, polyethylene (including high-density polyethylene, middle-density polyethylene, low-density polyethylene, and linear low-density polyethylene) or a copolymer of ethylene and propene. The stated copolymer includes ethylene-vinyl acetate copolymer, ethylene-vinyl alcohol copolymer, ethylene-methyl acrylate copolymer, ethylene-ethyl acrylate copolymer, ethylene-acrylate copolymer, and ethylene-butyl acrylate copolymer; the stated thermoformable fluorine-containing polymer includes polyvinylidene fluoride, ethylene/tetrafluoroethylene copolymer, and the like.

The conductive powder may be, for example, titanium carbide, tungsten carbide, titanium silicon carbide, titanium aluminum carbide, and titanium tin carbide. The titanium silicon carbide, titanium aluminum carbide, and titanium tin carbide have property similar to tungsten carbide.

The above-mentioned conductive powder has a quasi-spherical shape. Herein, the term “quasi-spherical” includes a spherical shape and a shape similar to a spherical shape.

The average particle size of the conductive powder may be from 0.1 μm to 50 μm. In some implementation solutions according to the present invention, the size of the conductive powder satisfies: D₅₀<5 μm, and D₁₀₀<50 μm.

Preferably, to obtain ultra-low resistivity (less than 200 μΩ·cm), the conductive powder has a relatively wide size distribution. Preferably, 20>D₁₀₀/D₅₀>6, and more preferably, 10>D₁₀₀/D₅₀.

When two conductive powders are mixed to satisfy that D₁₀₀/D₅₀>6, a similar conclusion may also be obtained.

In addition, because a transition metal generally has a variable valence state, in its carbides, an M×C phase may exist (M denotes a transition metal, and x is greater than 1). The presence of this M×C phase reduces the total carbon content in the carbide. Tungsten carbide (WC) as an example. The theoretical total carbon content in pure WC is 6.18%. However, a WC phase usually contains W₂C (W₂C is a sub-stable state phase). When WC contains a small amount of W₂C, the total carbon content is reduced. Under a condition of similar particle size distribution, a carbide having relatively low carbon content has slightly low resistivity. For example, when the carbon content in tungsten carbide is T.C.<6.0% (wherein T.C. is 100%×C/WC by mass), particularly, low resistance may be obtained when the content of T.C. is about 5.90%. When T.C.>6.0%, the resistivity is slightly high. Therefore, in some implementation solutions according to the present invention, preferably, the carbon content in the transition metal carbide is less than the theoretical total carbon content in a pure transition metal carbide MC (M is a transition metal element) by a particular value.

Preferably, the carbon content in the transition metal carbide is less than the theoretical total carbon content in a transition metal carbide MC of a stoichiometric ratio by 2% to 5%, wherein M denotes a transition metal element. When the conductive powder is tungsten carbide (WC), the carbon content T.C. in WC is 5.90% to 6.00%, wherein T.C. is 100%×C/WC by mass; or when the conductive powder is titanium carbide (TiC), the carbon content T.C. in TiC is 19.0% to 19.5%, wherein T.C. is 100%×C/TiC by mass.

In the PPTC sheet material, to enable the conductive powder to be uniformly dispersed in the polymer, a volume ratio of the polymer to the conductive powder may be 35:65 to 65:35, preferably, 40:60 to 60:40, and more preferably, 45:55 to 55:45, that is, the conductive powder and the polymer are mixed at an approximately equal volume ratio.

The PPTC sheet material may contain a component other than the above-mentioned polymer and the conductive powder, for example, an inorganic filler or another polymer material, the prerequisite is do not impair the low resistance and the processing performance of the PPTC sheet material in the present invention.

According to an embodiment of the present invention, the resistivity of the PPTC sheet material at unprotected state (that is, a high-temperature state) is below 200 μΩ·cm.

It should be understood that, the foregoing implementation solutions and embodiments are only used to describe the present invention rather than to limit the scope of the present invention. Technical persons of this field may make various modifications and changes without departing from the spirit of the present invention. The scope of the present invention is defined by the appended claims.

1. A positive temperature coefficient (PTC) circuit protection device comprising:
a conductive upper terminal including a first chip junction portion, a first circuit junction portion, and a connecting portion between the first chip junction portion and the first circuit junction portion, wherein the first chip junction portion has a first planar profile;
a conductive lower terminal including a second chip junction portion, wherein the second chip junction portion has a second planar profile;
a PTC chip that is sandwiched between the upper terminal and the lower terminal and is separately bonded to a lower surface of the first chip junction portion and an upper surface of the second chip junction portion by solder, the PTC chip having a third planar profile,
wherein the stated first planar profile and the second planar profile are inside the third planar profile, and the stated third planar profile has a portion that is not covered by the first planar profile and/or second planar profile, to allow the PTC chip to have a room for free thermal expansion.

2. The PTC circuit protection device according to claim 1, wherein the area of the portion of the third planar profile that is not covered by the first planar profile is at least 20% of the area of the third planar profile, and/or the area of the uncovered portion of the stated third planar profile by the second profile is at least 20% of the area of the third planar profile.

3. The PTC circuit protection device according to claim 1, wherein the portion of the third planar profile that is not covered by the first planar profile and the portion of the third planar profile that is not covered by the second planar profile are staggered.

4. The PTC circuit protection device according to claim 1, wherein
an anti-overflow gap is provided between edges of the first planar profile and the third planar profile, and/or an anti-overflow gap is provided between edges of the second planar profile and the third planar profile.

5. The PTC circuit protection device according to claim 1, wherein
the first chip junction portion and/or the second chip junction portion have a through hole.

6. The PTC circuit protection device according to claim 5, wherein
the first chip junction portion has a plurality of through holes.

7. The PTC circuit protection device according to claim 1, wherein notches are formed in edges of two sides of the connecting portion.

8. The PTC circuit protection device according to claim 1, wherein the connecting portion is curved, so that a lower surface of the first circuit junction portion and a lower surface of the second chip junction portion are on the same plane.

9. The PTC circuit protection device according to claim 1, wherein the lower terminal further includes a circuit junction portion extending from the second chip junction portion.

10. The PTC circuit protection device according to claim 1, wherein the PTC chip is a polymeric PTC (PPTC) chip, the PPTC chip comprises a PPTC sheet material, the stated PPTC sheet material contains a conductive powder dispersed in a polymer, a volume ratio of the polymer to the conductive powder is 35:65 to 65:35, the polymer comprises at least one selected from polyolefin, a copolymer of at least one olefin and at least one non-olefinic monomer copolymerizable therewith, and a semicrystalline polymer of a thermoformable fluorine-containing polymer the stated conductive powder comprising at least one powder of a transition metal carbide, a transition metal carbon silicide, a transition metal carbon aluminide, and a transition metal carbon stannide, and a size distribution of the conductive powder satisfies: 20>D₁₀₀/D₅₀>6, wherein D₅₀ denotes a corresponding particle size when a cumulative particle-size distribution percent in the conductive powder reaches 50%, and D₁₀₀ denotes a maximum particle size.

11. The PTC circuit protection device according to claim 10, wherein the conductive powder comprises titanium carbide, tungsten carbide, titanium silicon carbide, titanium aluminum carbide or titanium tin carbide.

12. The PTC circuit protection device according to claim 10, wherein the conductive powder is quasi-spherical.

13. The PTC circuit protection device according to claim 10, wherein the size distribution of the conductive powder satisfies:
10>D₁₀₀/D₅₀>6.

14. The PTC circuit protection device according to claim 10, wherein the carbon content in the transition metal carbide is less than the theoretical total carbon content in a transition metal carbide MC of a stoichiometric ratio by 2% to 5%, wherein M denotes a transition metal element.

15. The PTC circuit protection device according to claim 14, wherein the conductive powder is tungsten carbide WC. and the carbon content T.C. in WC is 5.90% to 6.00%. wherein T.C. is 100%×C/WC by mass; or the conductive powder is titanium carbide TiC. and the carbon content T.C. in TiC is 19.0% to 19.5%. wherein T.C. is 100% ×C/TiC by mass.

16. (canceled)

17. (canceled)
